(19) United States
(12) Patent Application Publication
(10) Pub. No.: US 2025/0274009 A1
(43) Pub. Date: Aug. 28, 2025

(54) DIRECT DRIVE GEAR REDUCER MOUNTING SYSTEMS

(71) Applicant: Roller Bearing Company of America, Inc., Oxford, CT (US)

(72) Inventors: Daniel Strevel, Oxford, CT (US); Justin Moulton, Oxford, CT (US); Steve Jones, Oxford, CT (US); Cordell McCurry, Oxford, CT (US); David Keech, Oxford, CT (US)

(73) Assignee: Roller Bearing Company of America, Inc., Oxford, CT (US)

(21) Appl. No.: 19/054,875

(22) Filed: Feb. 16, 2025

Related U.S. Application Data
(60) Provisional application No. 63/556,486, filed on Feb. 22, 2024.

(51) Int. Cl. H02K 7/116; H02K 9/19

(52) U.S. Cl. CPC H02K 7/116; H02K 9/19

(57) ABSTRACT

A mounting system is provided that includes an electric motor, a gear reducer, a coupling, and a mounting bracket. The electric motor has an output shaft and a foot at a bottom of the electric motor. The gear reducer has an input shaft at a drive face. The coupling operatively connects the output shaft and the input shaft. The mounting bracket is secured to the drive face of the gear reducer and to the foot of the electric motor.

### CROSS REFERENCE TO RELATED APPLICATIONS

This application claims benefit of U.S. Provisional Application 63/556,486 filed Feb. 22, 2024, the entire contents of which are incorporated herein by reference.

### BACKGROUND

### 1. Field of the Invention

The present disclosure is related to gear reducers. More particularly, the present disclosure is related to mounting systems for gear reducers.

### 2. Description of Related Art

Industrial equipment such as, but not limited to, conveyors, packaging devices, manufacturing devices and others, commonly use electric motors and gear reducers to provide movement to various system components. In some instances, the gear reducers are directly mounted to the electric motor in what is commonly called a “direct drive reducer”.” When using direct drive gear reducers, the mounting systems must be sufficient to transmit the torque from the motor through the gear reducer to the driven equipment.

A competing design constraint can be the need to minimize the size of the mounting system, which allows the system of the motor, reducer, and mounting system to fit within the available space of the end user.

While some mount systems for direct drive gear reducers are commercially available, it has been determined by the present disclosure that these solutions are not scalable to larger sized installations. It has also been determined by the present disclosure that even if the prior art mount systems were scalable, these systems fail to provide sufficient stress and/or thermal management of the drive train when in use.

Accordingly, there is a need for mounting systems that overcome, alleviate, and/or mitigate one or more of the aforementioned and other deleterious effects of the prior art.

### SUMMARY

A mounting system is provided that includes an electric motor, a gear reducer, a coupling, and a mounting bracket. The electric motor has an output shaft and a foot at a bottom of the electric motor. The gear reducer has an input shaft at a drive face. The coupling operatively connects the output shaft and the input shaft. The mounting bracket is secured to the drive face of the gear reducer and to the foot of the electric motor.

In some embodiments either alone or together with any one or more of the aforementioned and/or after-mentioned embodiments, the mounting system further includes a tie-rod secured to the mounting bracket on a side opposite the electric motor.

In some embodiments either alone or together with any one or more of the aforementioned and/or after-mentioned embodiments, the mounting bracket includes one or more lifting points.

In some embodiments either alone or together with any one or more of the aforementioned and/or after-mentioned embodiments, the mounting system further includes an I-beam mount secured to a reducer foot at a bottom of the gear reducer.

In some embodiments either alone or together with any one or more of the aforementioned and/or after-mentioned embodiments, the mounting system further includes a tie-rod secured to the I-beam mount on a side opposite the gear reducer.

In some embodiments either alone or together with any one or more of the aforementioned and/or after-mentioned embodiments, the mounting system further includes a fan operatively secured to the electric motor.

In some embodiments either alone or together with any one or more of the aforementioned and/or after-mentioned embodiments, the fan draws in air axially across the gear reducer towards the electric motor and forces the air radially outward.

In some embodiments either alone or together with any one or more of the aforementioned and/or after-mentioned embodiments, the gear reducer has a secondary shaft driving an oil pump. The oil pump places the gear reducer in fluid communication with an oil cooler. The oil cooler is positioned so that the air is forced across the oil cooler.

In some embodiments either alone or together with any one or more of the aforementioned and/or after-mentioned embodiments, the mounting system further includes a shroud between the electric motor and the gear reducer so as to cover the output shaft, the input shaft, the coupling, and the fan.

In some embodiments either alone or together with any one or more of the aforementioned and/or after-mentioned embodiments, the mounting system further includes a shroud between the electric motor and the gear reducer so as to cover the output shaft, the input shaft, and the coupling.

A mounting system is also provided that has an electric motor, a gear reducer, a coupling, a fan, and a shroud. The electric motor has an output shaft. The gear reducer has an input shaft at a drive face. The coupling operatively connects the output shaft to the input shaft. The fan is operatively secured to the electric motor. The shroud is between the electric motor and the gear reducer to cover the output shaft, the input shaft, the coupling, and the fan. The fan draws in air axially across the gear reducer and forces the air towards the electric motor where the air exits the shroud radially outward.

In some embodiments either alone or together with any one or more of the aforementioned and/or after-mentioned embodiments, the gear reducer includes a secondary shaft driving an oil pump. The oil pump places the gear reducer in fluid communication with an oil cooler. The oil cooler is positioned so that the air is forced across the oil cooler by the fan.

In some embodiments either alone or together with any one or more of the aforementioned and/or after-mentioned embodiments, the mounting system further includes a mounting bracket secured to the drive face of the gear reducer and to a foot at the bottom of the electric motor.

In some embodiments either alone or together with any one or more of the aforementioned and/or after-mentioned embodiments, the mounting bracket has one or more lifting points.

In some embodiments either alone or together with any one or more of the aforementioned and/or after-mentioned embodiments, the mounting system further includes a tie-rod secured to the mounting bracket on a side opposite the electric motor.

In some embodiments either alone or together with any one or more of the aforementioned and/or after-mentioned embodiments, the mounting system further includes an I-beam mount secured to a reducer foot at a bottom of the gear reducer.

The above-described and other features and advantages of the present disclosure will be appreciated and understood by those skilled in the art from the following detailed description, drawings, and appended claims.

### DESCRIPTION OF THE DRAWINGS

This application contains at least one drawing executed in color. Copies of this patent or patent application publication with color drawing(s) will be provided by the Office upon request and payment of the necessary fee.

FIG. 1 is a top perspective view of an exemplary embodiment of a mounting system according to the present disclosure;

FIG. 2 is a first side view of the mounting system of FIG. 1;

FIG. 3 is a second, opposite side view of the mounting system of FIG. 1;

FIG. 4 is another first side view of the mounting system of FIG. 1 having a shroud removed;

FIG. 5A is a disassembled view of the mounting system of FIG. 1;

FIG. 5B is a disassembled view of a gear reducer according to the present disclosure;

FIG. 6 is a top perspective view of a shroud according to an exemplary embodiment of the present disclosure;

FIG. 7 is a disassembled view of the shroud of FIG. 6;

FIG. 8 is a rear view of the shroud of FIG. 6 having the shroud illustrated in phantom;

FIG. 9A is a side view of the gear reducer of FIG. 1 shown having four testing locations;

FIG. 9B is a sectional view of the mounting system of FIG. 1 taken at slice 3 of FIG. 9A;

FIGS. 10A-13A are air velocity simulations taken at the testing locations of FIG. 9A for a comparison shroud;

FIGS. 10B-13B are air velocity simulations taken at the testing locations of FIG. 9A for the shroud of the present disclosure;

FIG. 14A is a perspective view of a heat transfer simulation for a comparison shroud;

FIG. 14B is a perspective view of a heat transfer simulation for the shroud of the present disclosure;

FIG. 15 is a perspective view of a mounting bracket according to an exemplary embodiment of the present disclosure shown secured to a gear reducer;

FIG. 16 is a disassembled view the mounting bracket of FIG. 15;

FIG. 17 is a sectional view of the mounting bracket of FIG. 16 taken along lines 17-17;

FIG. 18 is a bottom perspective view of the mounting bracket in use with a foot mount;

FIG. 19 is a bottom perspective view of the mounting system of FIG. 1 in use with an I-beam and I-beam foot mount;

FIG. 20 is a top perspective view of the I-beam and I-beam foot mount of FIG. 19;

FIG. 21 is a top perspective view of an exemplary embodiment of a mounting bracket according to the present disclosure;

FIG. 22 is a top view of the mounting bracket of FIG. 21;

FIG. 23 is a bottom view of the mounting bracket of FIG. 21;

FIG. 24 is a first side view of the mounting bracket of FIG. 21;

FIG. 25 is a second, opposite side view of the mounting bracket of FIG. 21;

FIG. 26 is a first end view of the mounting bracket of FIG. 21;

FIG. 27 is a second, opposite end view of the mounting bracket of FIG. 21;

FIG. 28 is a top perspective view of an exemplary embodiment of a shroud according to the present disclosure;

FIG. 29 is a top view of the shroud of FIG. 28;

FIG. 30 is a bottom view of the shroud of FIG. 28;

FIG. 31 is a first side view of the shroud of FIG. 28;

FIG. 32 is a second, opposite side view of the shroud of FIG. 28;

FIG. 33 is a first end view of the shroud of FIG. 28; and

FIG. 34 is a second, opposite end view of the shroud of FIG. 28

### DETAILED DESCRIPTION

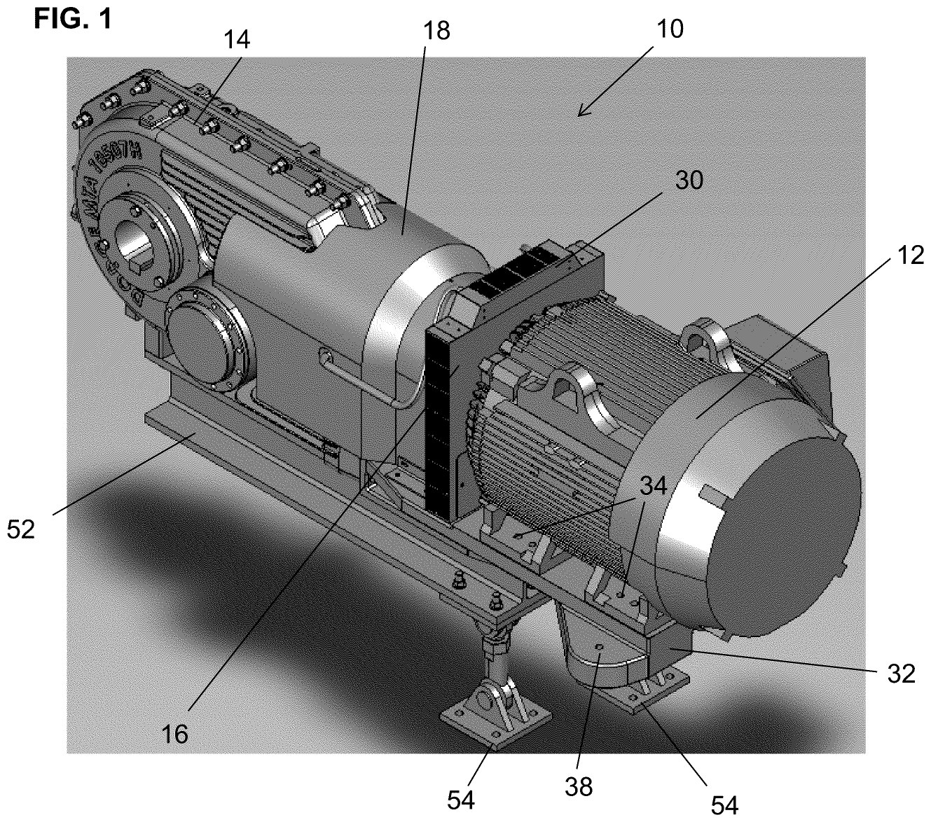

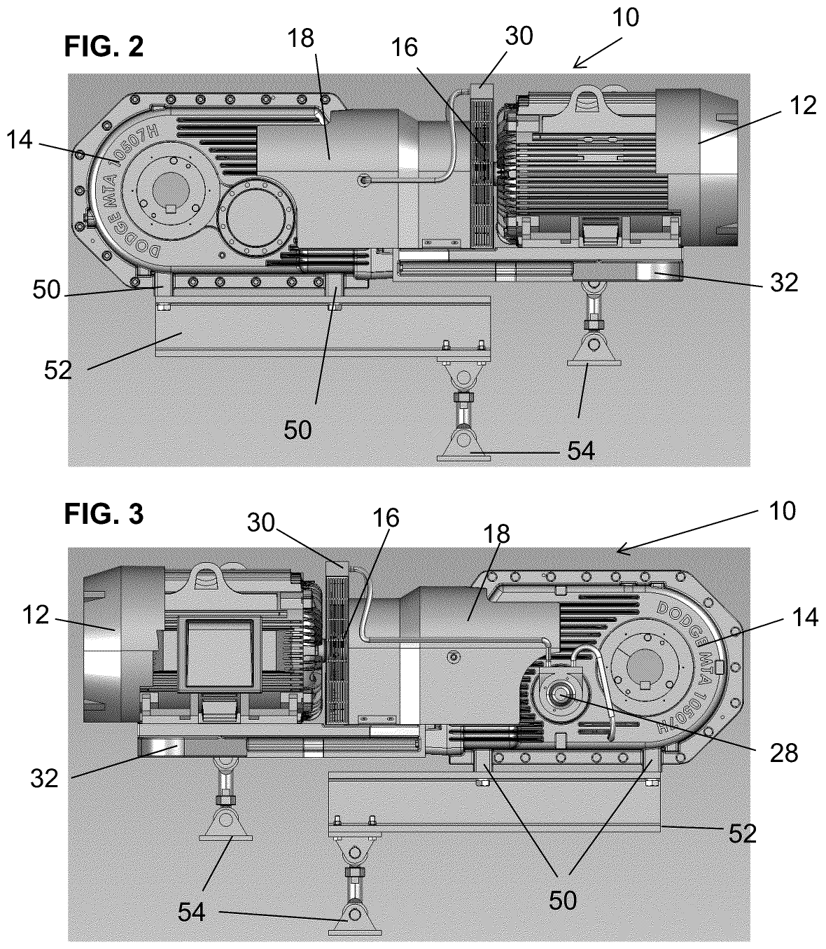

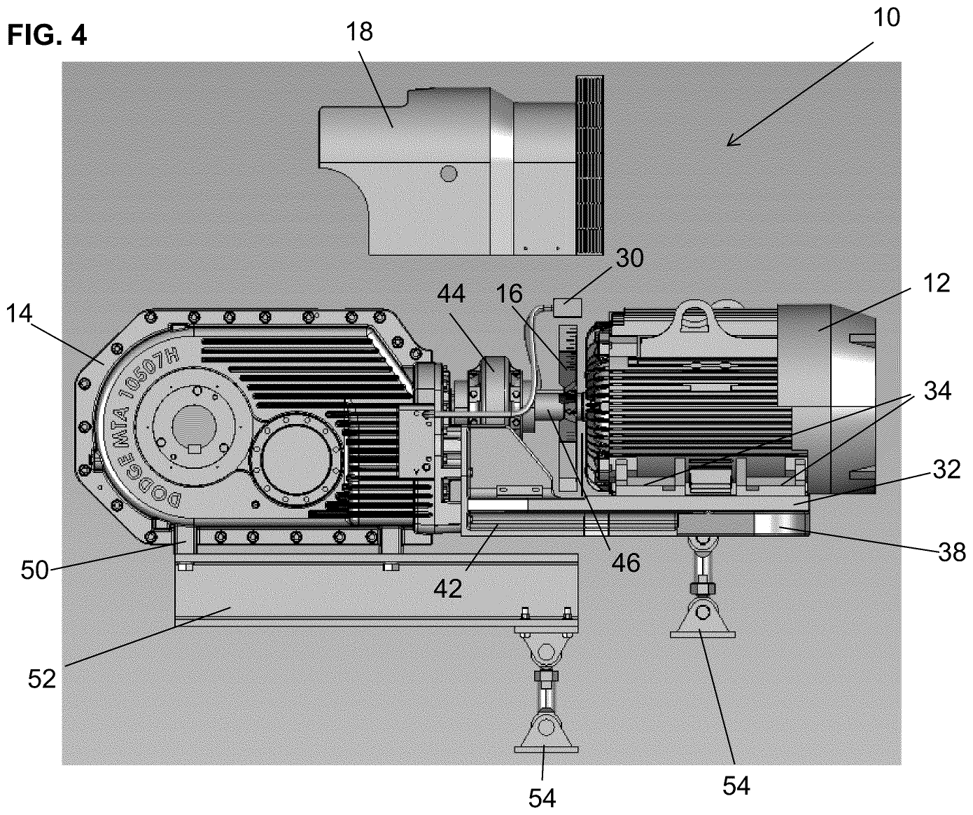

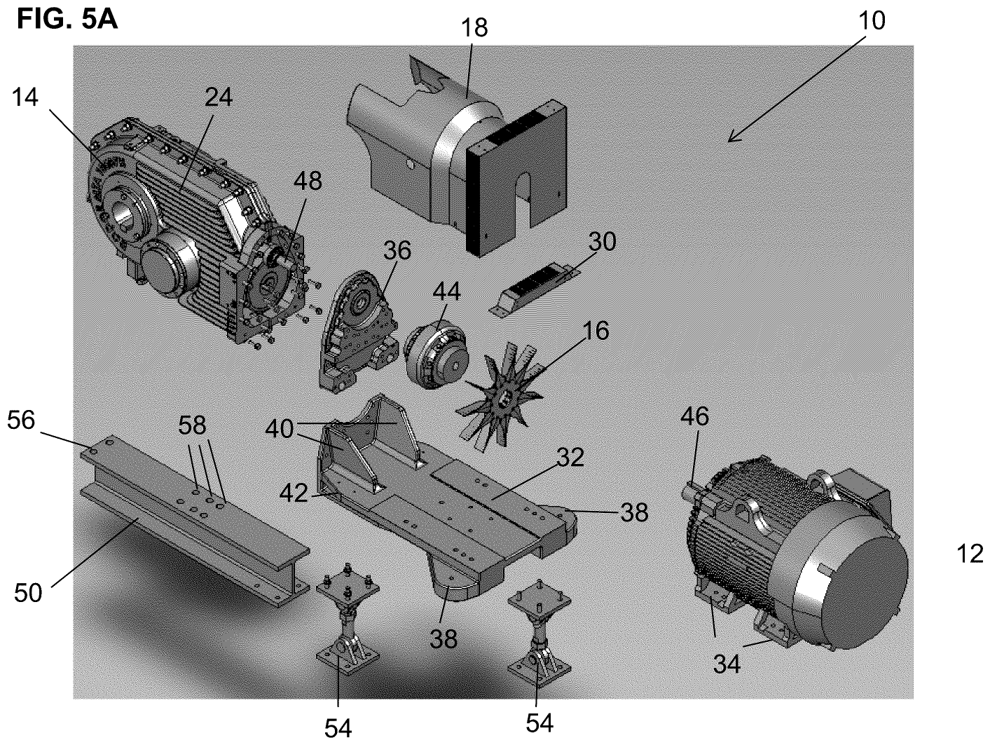

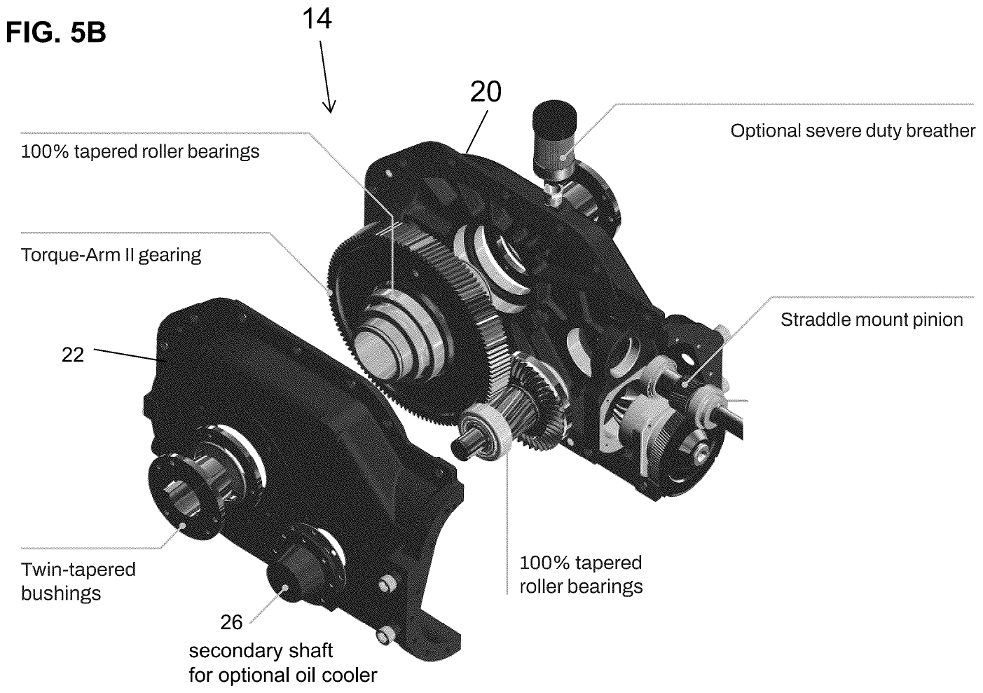

Referring to the drawings and in particular to FIGS. 1-5B, an exemplary embodiment of a mounting system according to the present disclosure is shown and is generally referred to by reference number 10. Advantageously, mounting system 10 is configured to secure an electric motor 12 and a direct drive gear reducer 14 to one another in a structurally stable and compact manner.

Additionally, mounting system 10 can, in some embodiments, include a cooling fan 16 that is driven by motor 12 to draw in ambient air and force the air across gear reducer 14, which pulls heat out of the gear reducer. In some embodiments, fan 16 is configured to draw air into system 10 axially across gear reducer 14, push the air towards motor 12, and to exhaust the air radially outward from shroud 18. Of course, it is contemplated by the present disclosure for fan 16 to have any desired configuration such as, but not limited to, drawing air in into shroud 18 radially at motor 12 and forcing the air axially towards gear reducer 14.

Motor 12 can be any electric machine having sufficient power to drive a driven device (not shown) operatively connected to gear reducer 14. In some embodiments, motor 12 is an electric motor having a horsepower rating of between 20 to 400, preferably between 40 and 340, more preferably between 60 and 300, and any subranges therebetween.

Reducer 14 can be any direct drive gear reducer. In the illustrated embodiment, gear reducer 14 is a beltless reducer having a split housing 20, 22 having cooling fins 24 defined on an exterior. Fins 24 are, preferably, positioned on housing 20, 22 in an axial direction, namely in a direction that is parallel to a direction of the flow of air drawn in by fan 16.

In some embodiments, gear reducer 14 can include a secondary shaft 26, which system 10 advantageously is configured to use to drive an oil pump 28 that is in fluid communication with an oil cooler 30. Oil cooler 30 is positioned so that air that is drawn in to shroud 18 by fan 16 passes through and exchanges heat with the oil in the oil cooler. Simply stated, pump 28 pumps heated oil from gear reducer 14 through cooler 30, where heat in the oil is removed by fan 16 and returns the oil to the gear reducer.

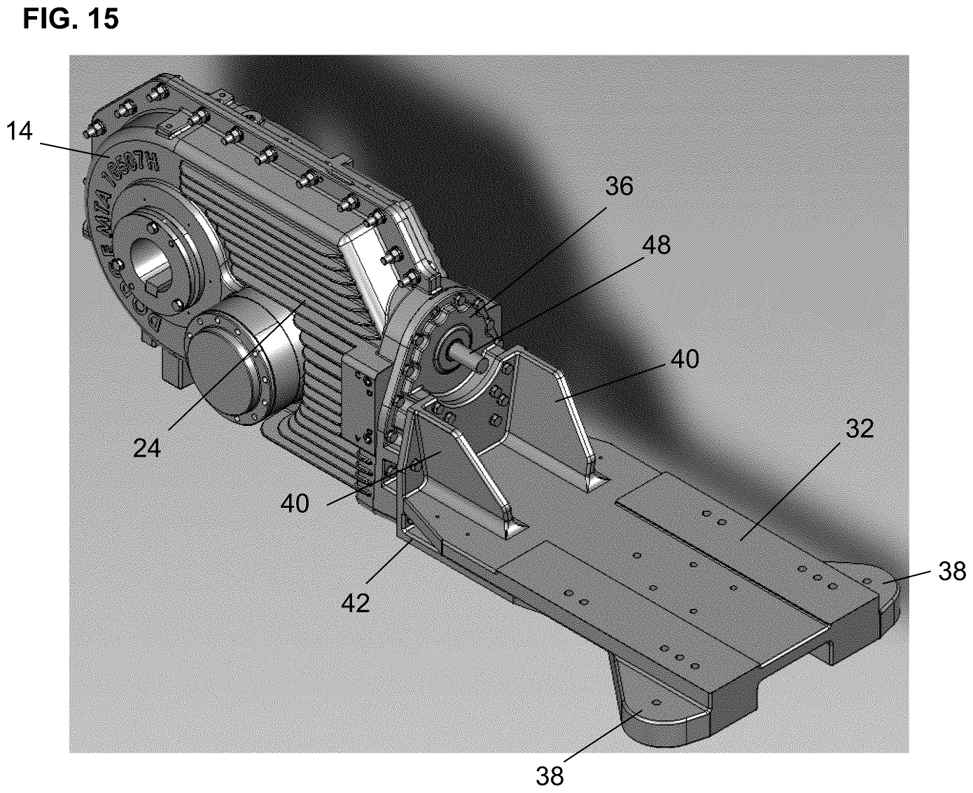

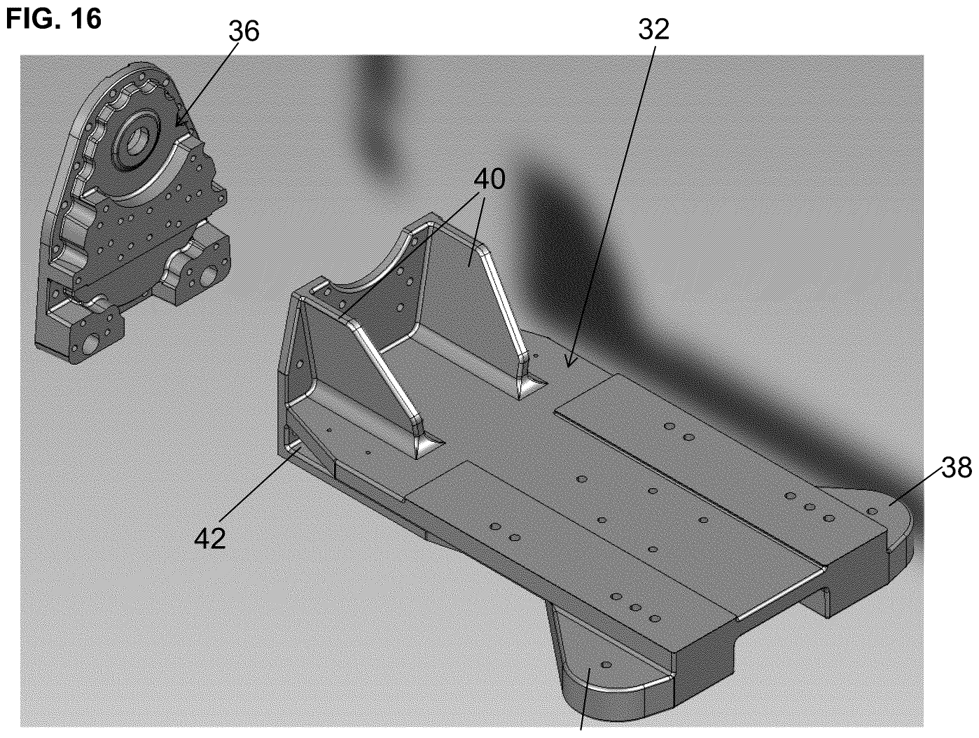

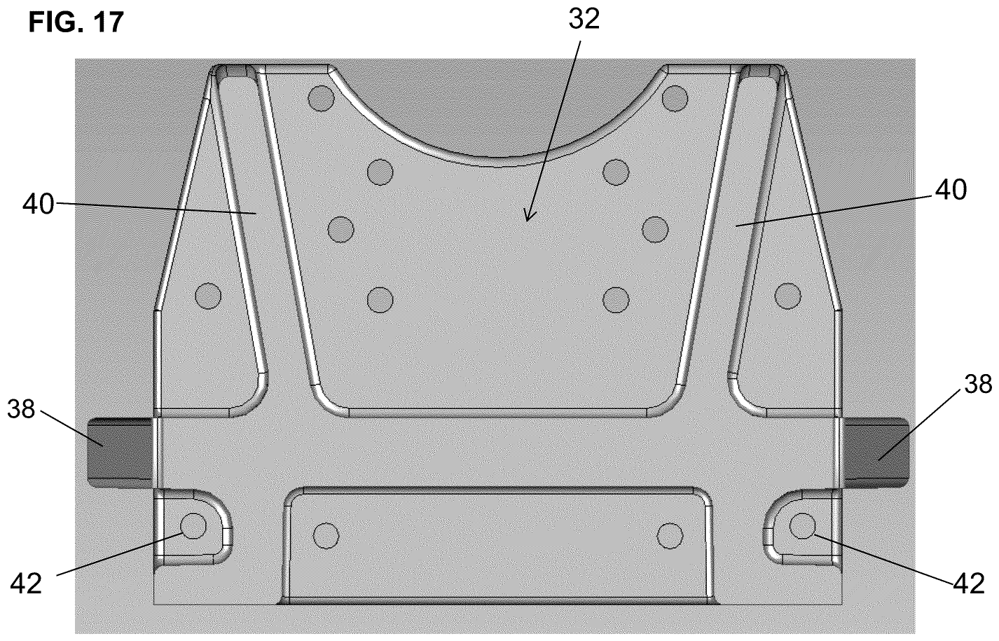

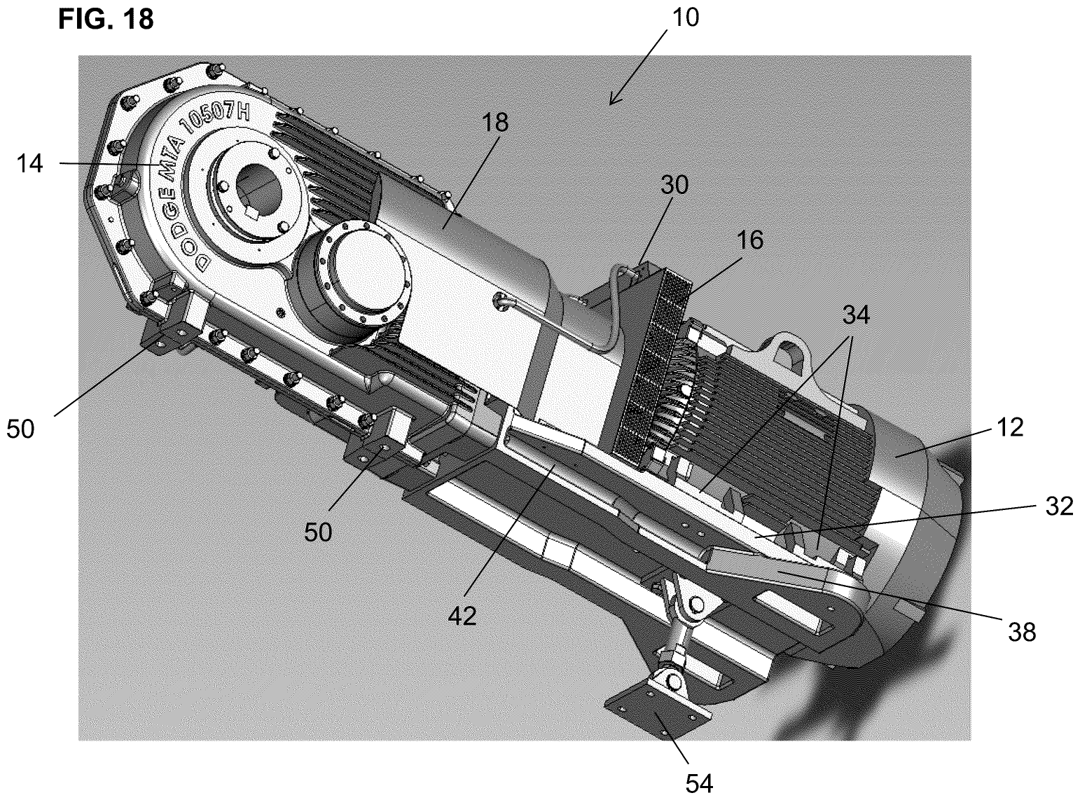

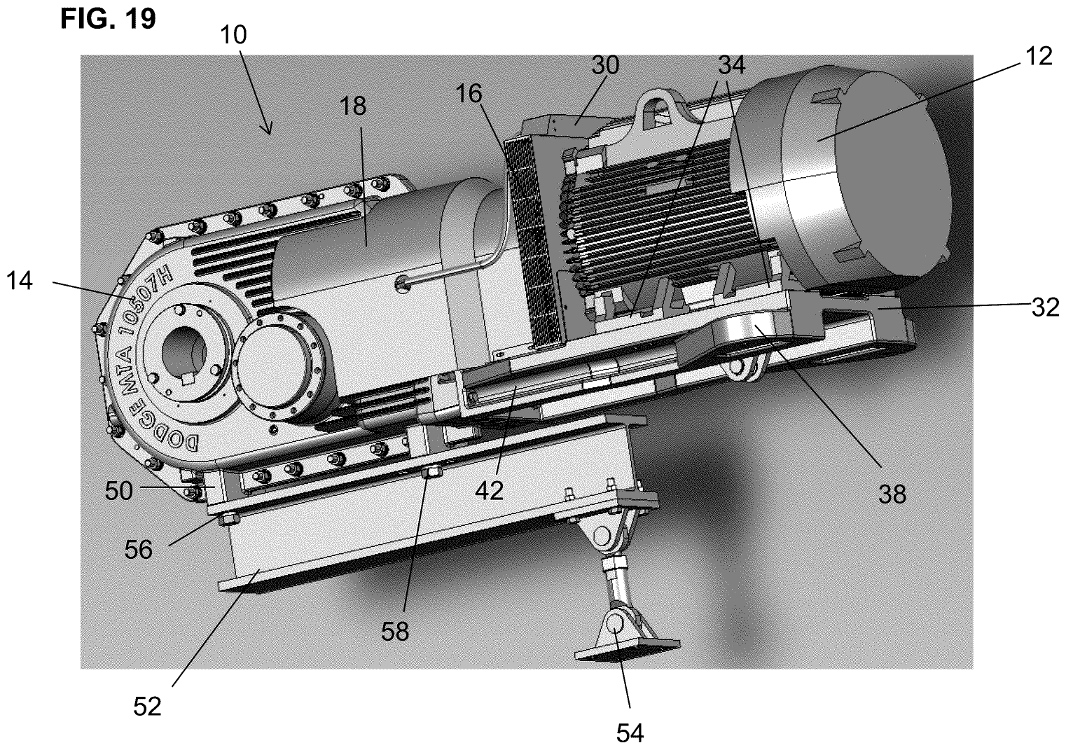

System 10 includes a mounting bracket 32 that is mounted to one or more feet 34 of motor 12 and mounted to a drive face 36 of gear reducer 14. Thus, bracket 32 provides a structural member that is secured to drive face 36 in a cantilevered manner so that the bracket is secured to feet 34 of motor 12. Bracket 32 is described in more detail with reference to FIGS. 15-18.

Advantageously, system 10, due at least in part to bracket 32 being secured to drive face 36, provides a structurally secure connection of motor 12 and gear reducer 14 in a simple and structurally secure manner that reduces the space necessary to secure the components to one another as compared to prior art connections.

In some embodiments, bracket 32 can include one or more lifting points 38 integrally formed therewith.

Bracket 32 is configured to provide a rigid base between motor 12 and gear reducer 14, reducing stress to the shafts and bearings in system 10. In some embodiments, bracket 32 can be a cast metallic support. Bracket 32 can have a cross section with gussets 40 and/or C-shaped bottom rails 42, which provide the bracket with sufficient section modulus to resist the applied bending moment. In some embodiments, gussets 40 are angled to provide sufficient space to receive a coupling 44 therebetween.

Further, bracket 32 provides a closed bottom to the area enclosed by shroud 18 to improve the flow of air through the shroud due to fan 16.

System 10 further includes coupling 44 that operatively connects an output shaft 46 of motor 12 to an input shaft 48 of gear reducer 14. In some embodiments, coupling 44 can provide one or more degrees of freedom between output and input shafts 46, 48. The one or more degrees of freedom can compensate for tolerances such as, but not limited to, runout of the output/input shafts 46, 48, which can transmit damaging radial loads into bearings of gear reducer 14.

In one embodiment, coupling 44 is an elastomeric coupling such as those commercially available from Applicant and known as the Dodge Raptor coupling.

Moreover, system 10 leaves feet 50 of gear reducer 14 free from the connection with motor 12, which provides the ability for system 10 to, in some embodiments, a further support shown as an I-beam mount 52. Here, feet 40 can be machined to a flat plane so as to ensure a secure connection with I-beam mount 52.

System 10 can include one or more tie-rods 54 that secure bracket 32 or I-beam mount 52 to a rigid mounting location (not shown). In the illustrated embodiment, bracket 32 is configured so that tie-rod 54 is secured to a bottom of the bracket at an approximate location of a center of gravity of motor 12.

In the illustrated embodiment, fan 16 is operatively connected to output shaft 46 of motor 12. Of course, it is contemplated by the present disclosure for fan 16 to be operatively connected to input shaft 48 of gear reducer 14, to coupling 44, and any combinations thereof. Preferably, fan 16 is configured to draw in ambient air into shroud 18 axially across gear reducer 14, force the air axially along shafts 46, 48 within the shroud towards motor 12, and then radially out of shroud 18.

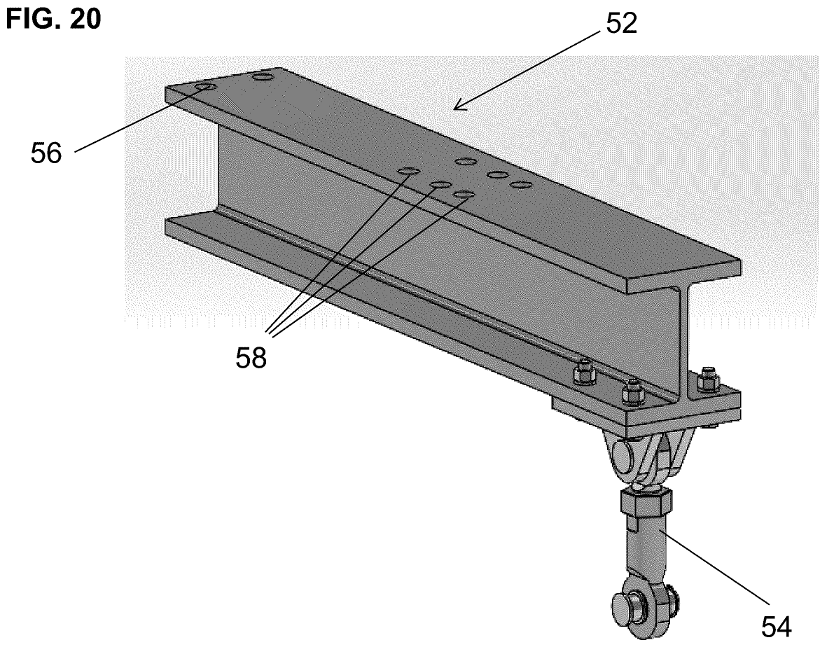

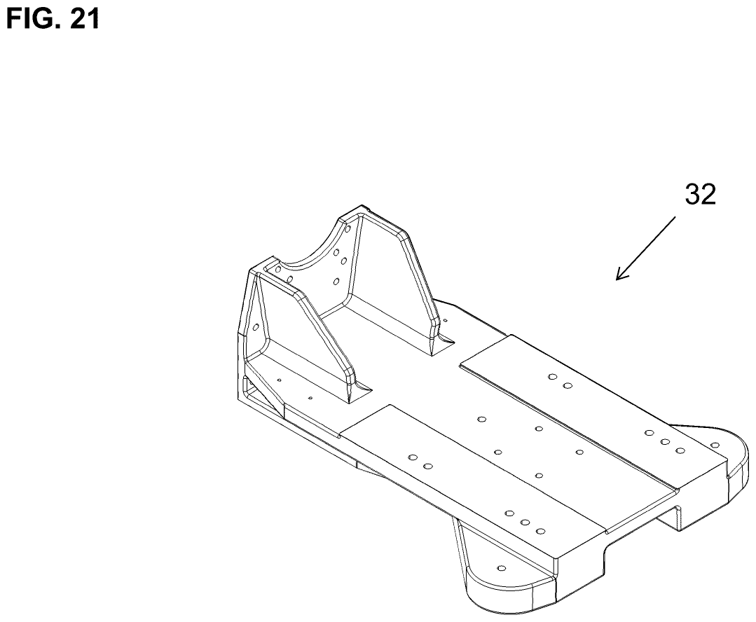

Referring now to FIGS. 20-21, I-beam mount 52 is described in more detail. Advantageously, I-beam mount 52 provides easy access to mechanical fasteners used to secure the mount to gear reducer 14. In some embodiments, best seen in FIG. 20, I-beam mount 52 includes a rear set of fastener openings 56 and a plurality of front sets of fastener openings 58.

The rear fastener openings 56 are securable to the rear feet 50 of gear reducer 14, while the front sets of fastener openings 58 can be selectively connected to the front feet 50 of reducer. In this manner, I-beam mount 52 can be used for connection to reducers 14 of different sizes—eliminating parts and increasing the compatibility of system 10. Here, the moment arm (i.e., the distance) between front fastener openings 58 and tie-rod 54 is reduced as the size of reducer and, thus, the torque applied to I-beam mount 52, increases.

Moreover, I-beam mount 52 serves as an extension for mounting the torque arm further away from the gearbox output moment than would otherwise be possible. Simply, I-beam mount 52 is configured, in some embodiments, so that front sets of fastener openings 58 are located at an axial direction past drive face 36 of gear reducer 14.

Reducer 14 is configured so that rear and front feet 50 are spaced from one another so that there is no overlap of the front openings 58 in I-beam 52, which allows the same I-beam to be used for multiple reducer sizes.

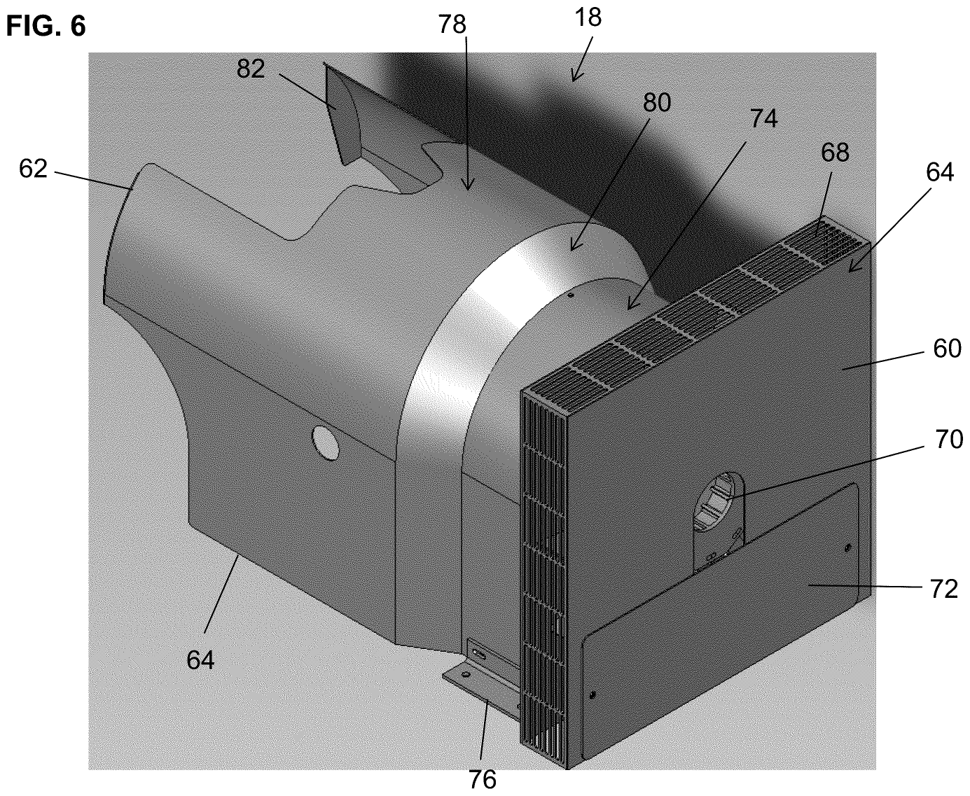

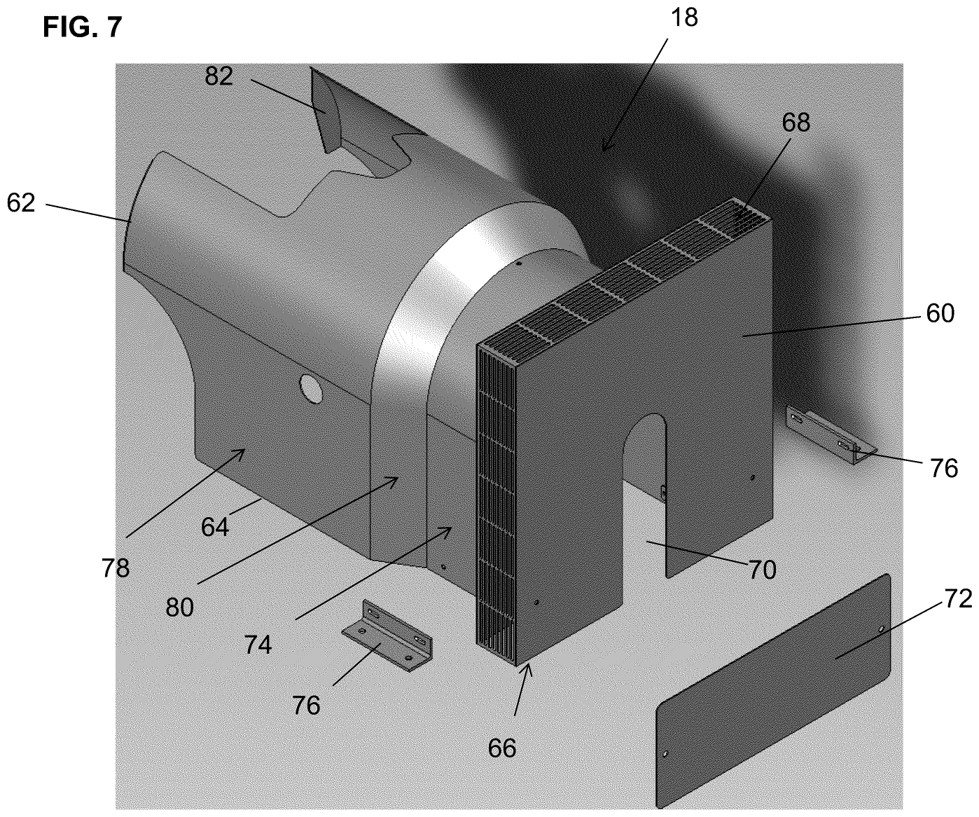

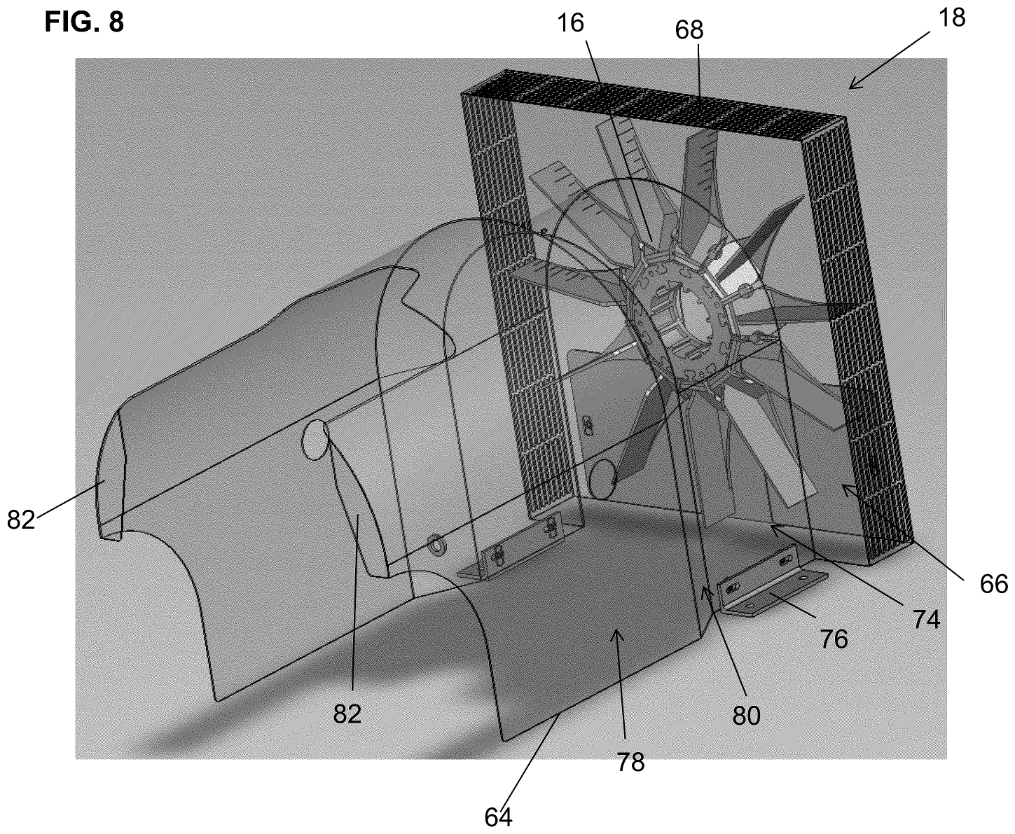

Shroud 18 is described in more detail with reference to FIGS. 6-14B.

Shroud 18 includes a first end 60 at motor 12, a second end 62 at gear reducer 14, and an open bottom end 64. Shroud 18 is secured between motor 12 and gear reducer 14 with open end 64 connected to bracket 32 in a manner sufficient to cover fan 16, output shaft 46, input shaft 48, coupling 44, and, when present, oil cooler 30. In this manner, shroud 32 can prevent inadvertent contact with the moving parts of system 10.

In addition, shroud 18 is advantageously configured to maximize the cooling efficiency of fan 16 by reducing ingress of air except through the inlet formed between second end 62 and gear reducer 14 and/or by reducing leakage of air except through the radial vents in first end 60.

Shroud 18 can include a fan cover region 66. Region 66 includes a plurality of air vents 68 at its outer extents so that air drawn in by fan 16 at second end 62 proximate gear reducer 14 is pulled axially through shroud 18 and forced radially outward from region 66 through the air vents 68. Without wishing to be bound by any particular theory, it is believed that exhausting of air drawn in by fan 16 radially through air vents 68 minimizes air flow restrictions through shroud 18, which increases the cooling capacity of system 10.

Region 66 includes a shaft slot 70 that permits shroud 18 to be positioned over output shaft 46 with bottom end 64 on bracket 32 at least at first end 60. In some embodiments, shroud 18 can include a slot cover 72 that can be connected to fan cover region 66 to block off shaft slot 70. Again and without wishing to be bound by any particular theory, it is believed that blocking off shaft slot 70 via cover 72 reduces air leakage at first end 60 proximate motor 12 axially outward and reduces suction of air axially into the first end-forcing the air to be drawn in at second end 62 proximate gear reducer 14.

Shroud 18 includes a narrowed region 74 prior, in the direction of airflow, to fan cover region 66. Again and without wishing to be bound by any particular theory, it is believed that fan cover region 66 having a larger outer dimension than narrowed region 74 provide enhanced cooling capacity.

For example, fan cover region 66 provides a substantially uniform suction area around fan 16 which can increase the efficiency of the fan 16. As another example, the narrowed region 74 provides an area where the air is accelerated as it is drawn into fan cover region 66.

In some embodiments, shroud 18 includes connectors 76 that connect bottom end 64 to bracket 32 at least in narrowed region 74. Connectors 76 are believed to reduce ingress of air except through the inlet formed between second end 62 and gear reducer 14 and/or by reducing leakage of air between bottom end 64 and bracket 32.

Shroud 18 further includes an air inlet region 78 at second end 62 proximate gear reducer 14. Inlet region 78 has a larger outer dimension than narrowed region 74. In some embodiments, shroud 18 includes a tapered zone 80 between narrowed region 74 and inlet region 78 to eliminate sharp turns in airflow. In still other embodiments, shroud 18 can include radial extensions 82 at second end 62. Extensions 82 are believed to ensure that the ingress of air through inlet region 78 occurs as close to gear reducer 14 as possible.

In some embodiments, air inlet region 78 is sized and configured to provide sufficient space to receive coupling 44 with sufficient degrees of freedom between shafts 46, 48.

In some embodiments, shroud 18 is configured so that narrowed region 74, air inlet region 78, and, when present, tapered zone 80 have a rounded or oval cross section. Without wishing to be bound by any particular theory, it is believed that the rounded cross section of shroud 18 at least in regions 74, 78, and 80 provides an increased air flow as compared to other configurations.

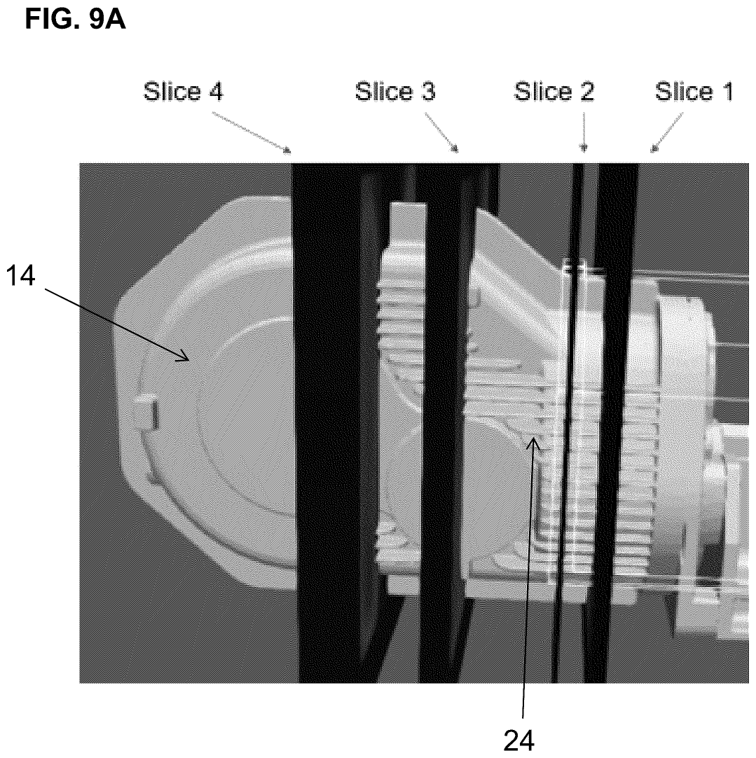

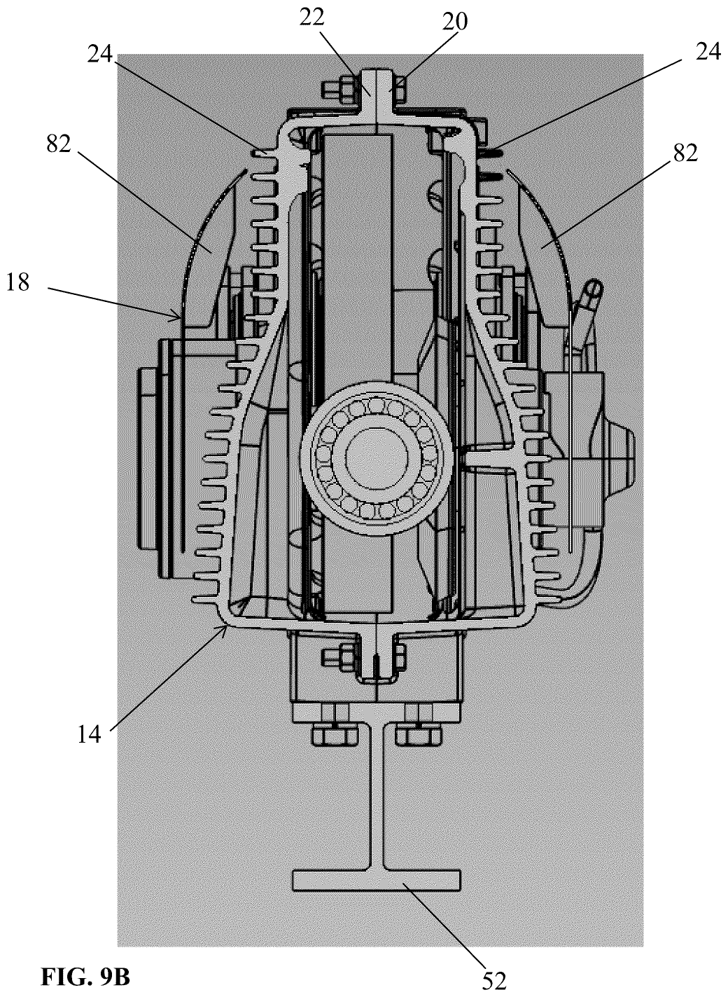

FIGS. 9A-14B illustrate air velocity and heat transfer capability testing performed using computational fluid dynamics (CFD) simulations.

FIG. 9A indicates the four locations or slices on which air velocity CFD simulations were performed. Slices 1 and 2 are taken within shroud 18, while slice 3 is taken at second end 62 of the shroud, namely at the location where air is drawn into the shroud. Slice 4 is taken at a location prior to second end 62 of shroud 18.

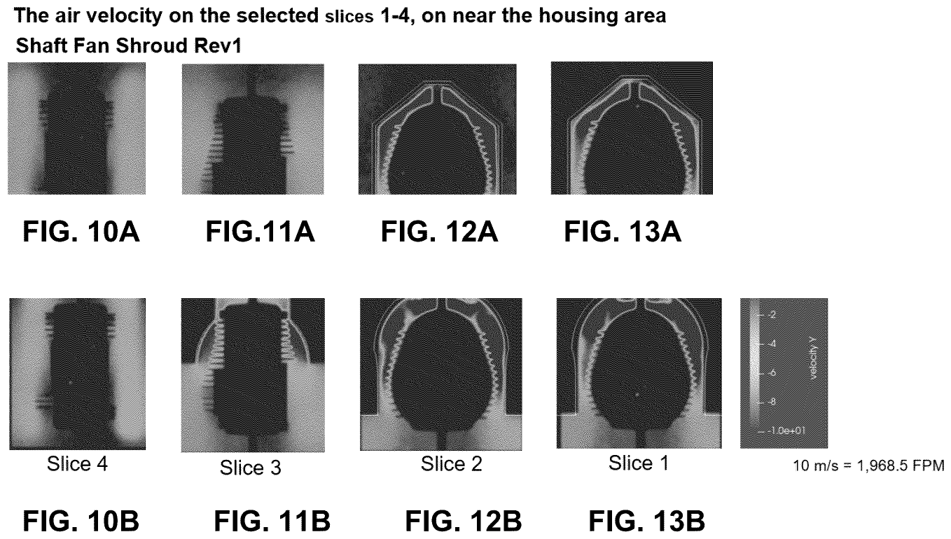

The air velocity simulation for a comparison shroud having an octagonal shape are shown in FIGS. 10A-13A, while the air velocity simulation for shroud 18 are shown in FIGS. 10B-13B.

Comparing FIGS. 10A to 10B, taken at a location where the comparison shroud and shroud 18 are not present, the air velocities are substantially similar.

Comparing FIGS. 11A to 11B, taken at the second end 62 or air inlet location for the comparison shroud and shroud 18, shroud 18 provides larger air velocities particularly in the upper regions of gear reducer 14.

Comparing FIGS. 12A to 12B and 13A to 13B, shroud 18 provides larger air velocities in the upper regions and lower regions of gear reducer 14.

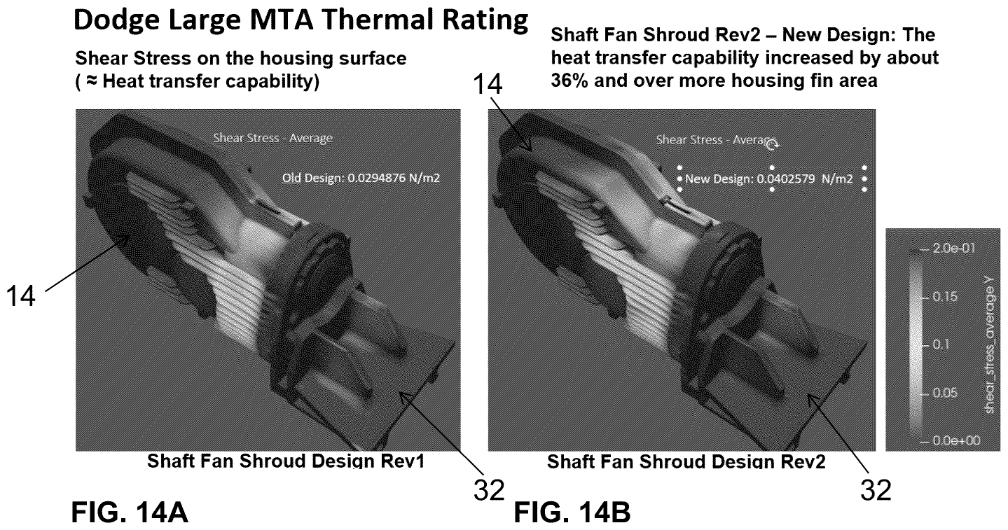

The heat transfer capability tests performed using computational fluid dynamics (CFD) simulations are shown in FIGS. 14A and 14B. Here, FIG. 14A shows the heat transfer capability for the comparison shroud having an octagonal shape, while FIG. 14B shows the heat transfer capability for shroud 18. Here, the heat transfer capability of shroud 18 is larger in both the central and upper regions of gear reducer 14.

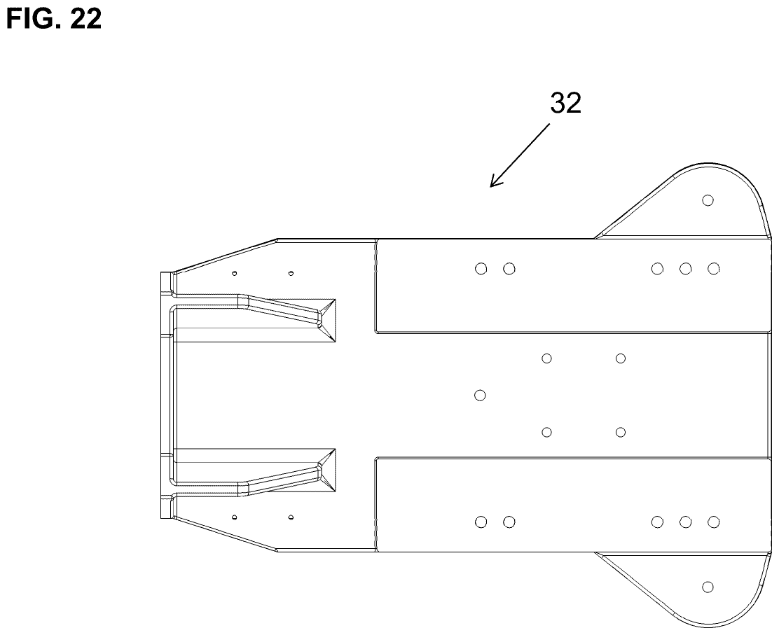

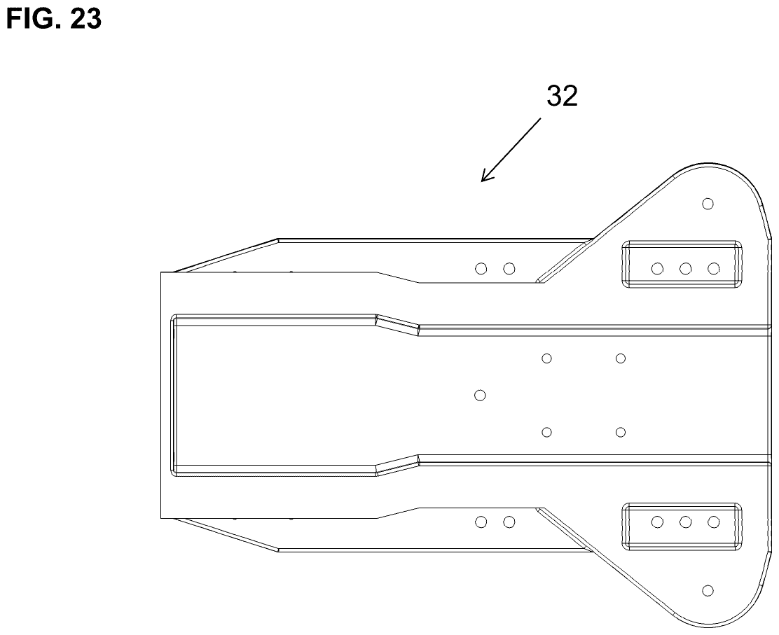

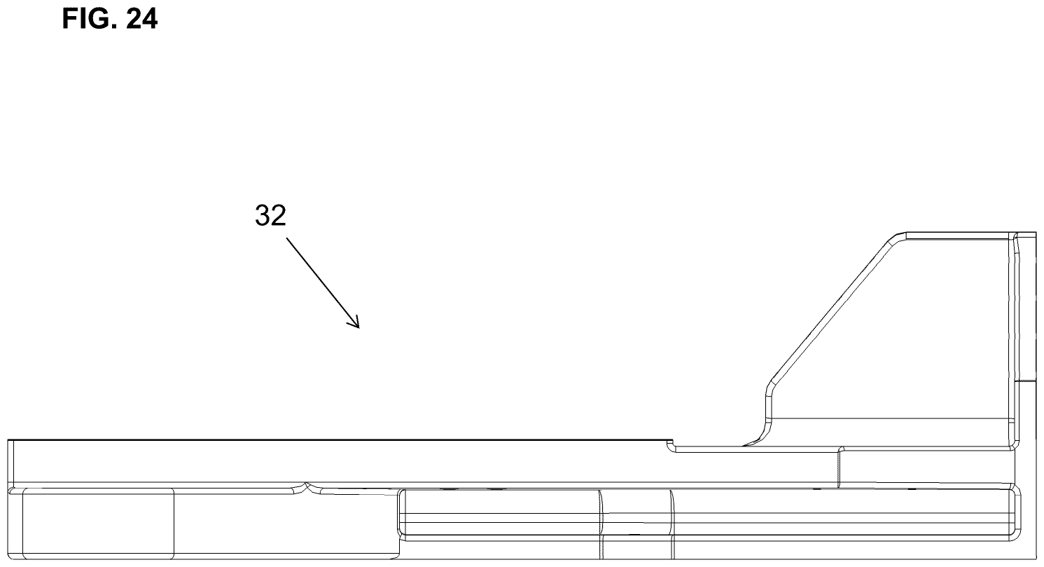

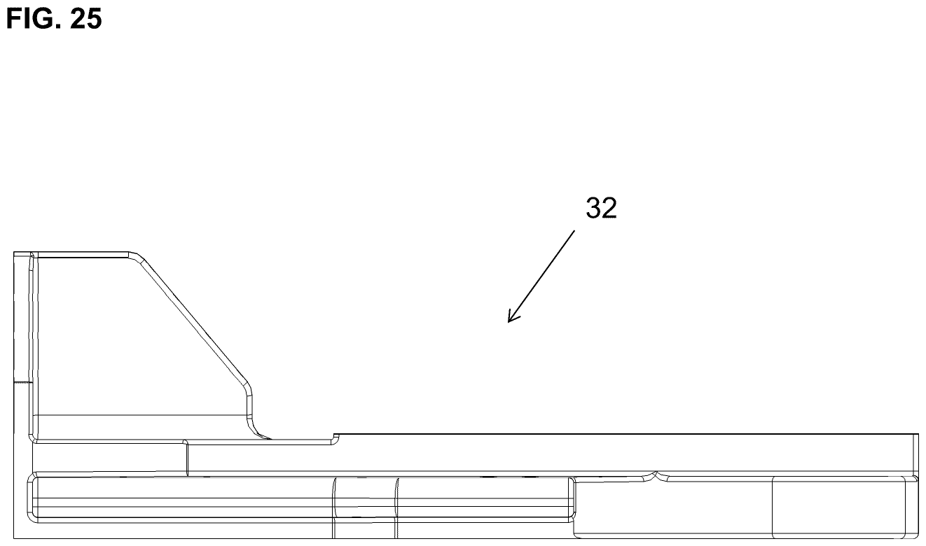

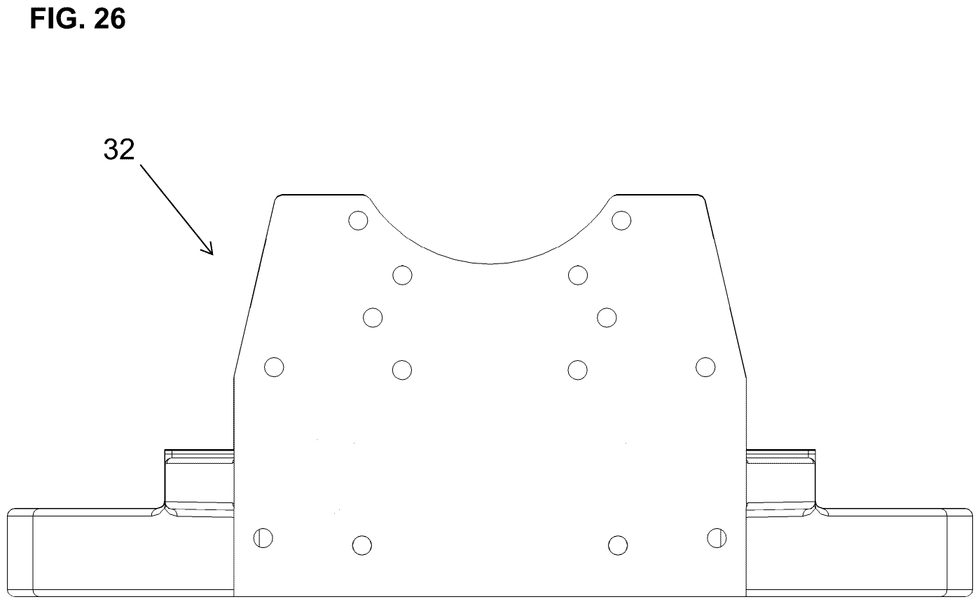

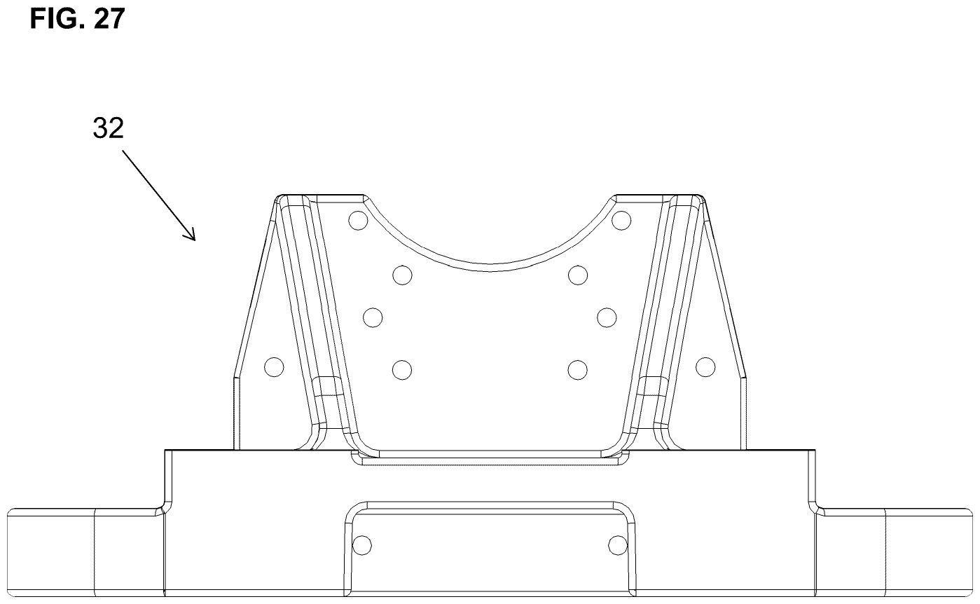

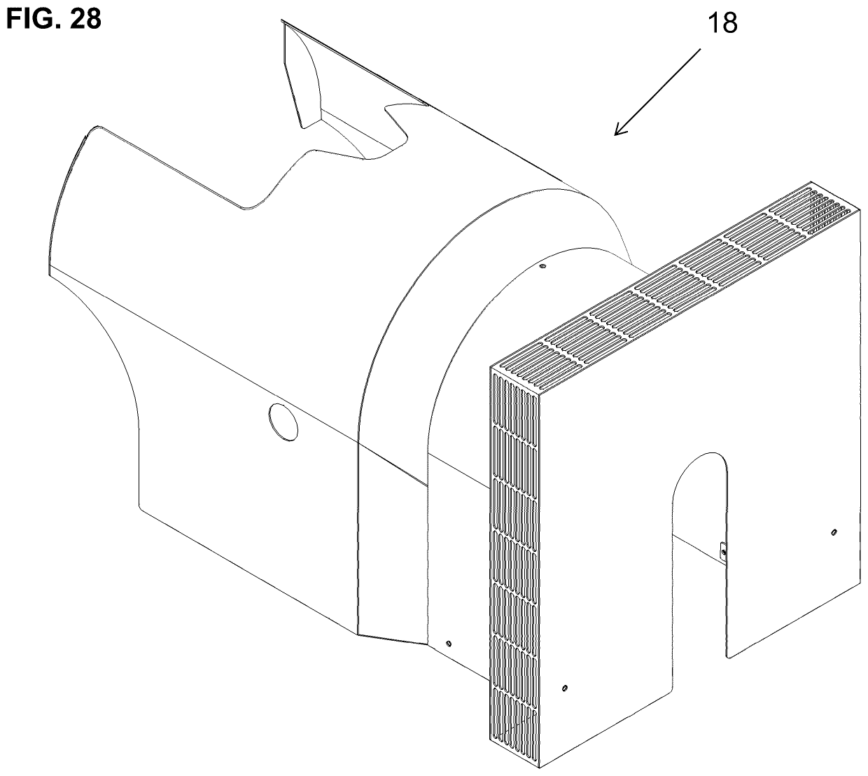

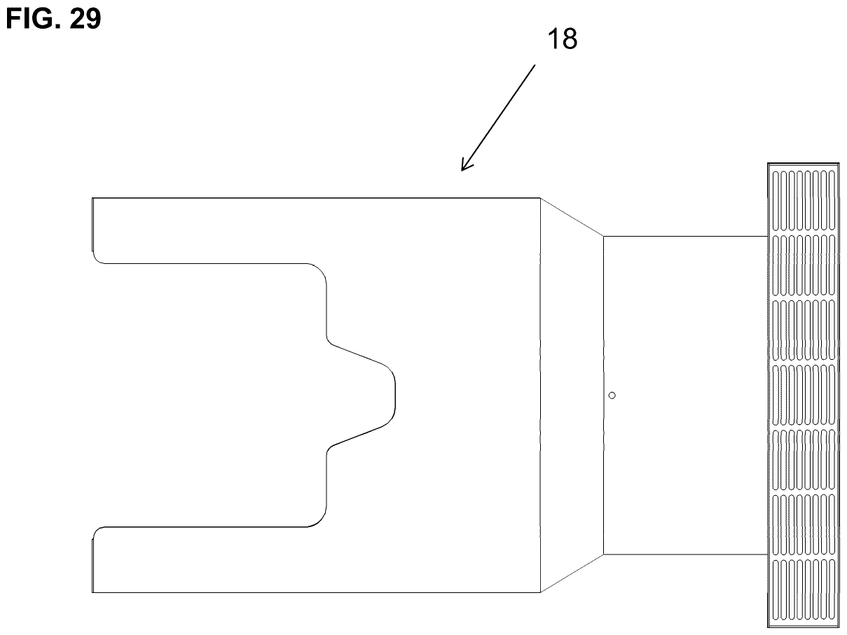

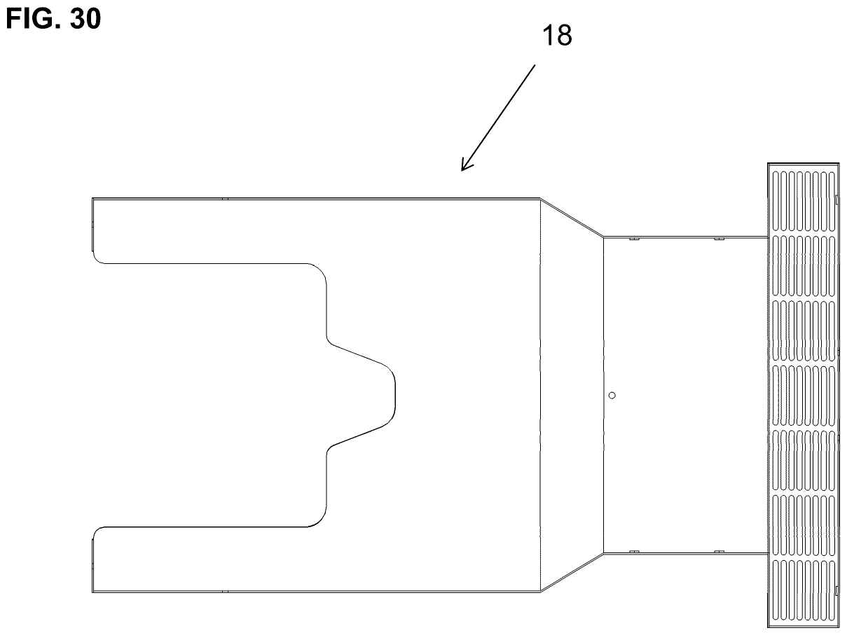

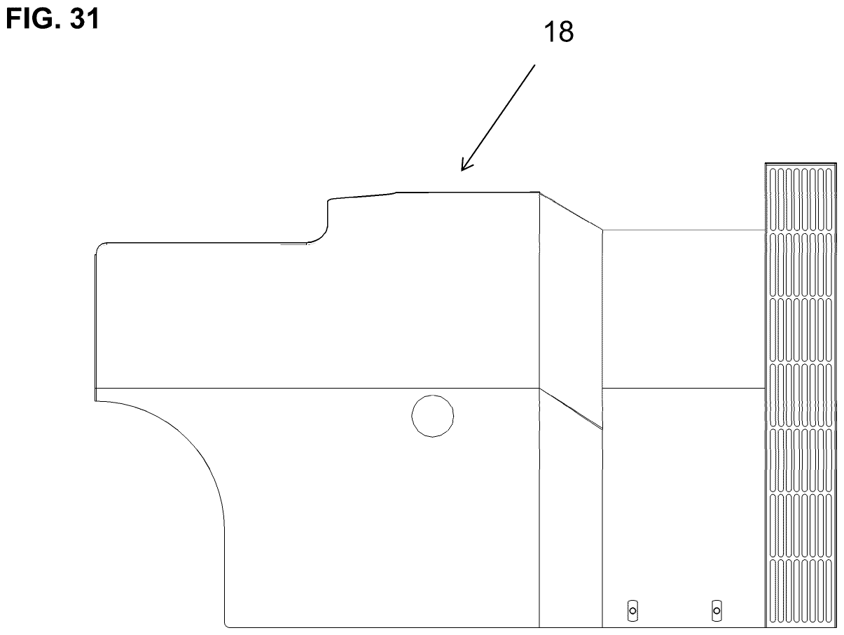

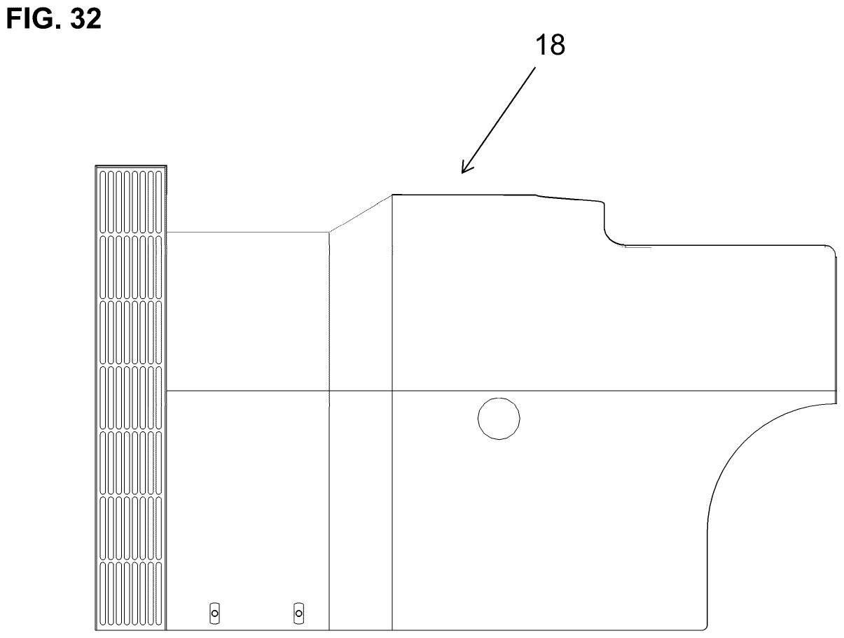

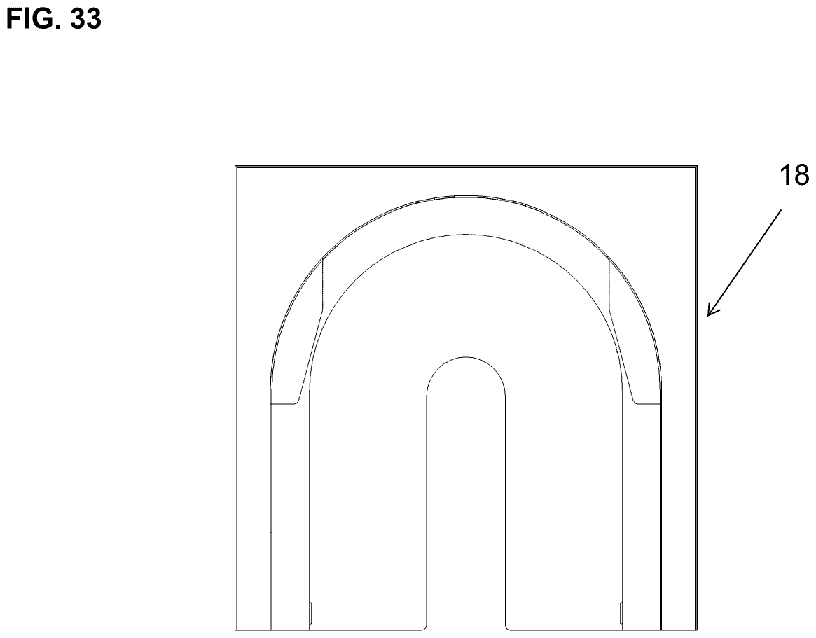

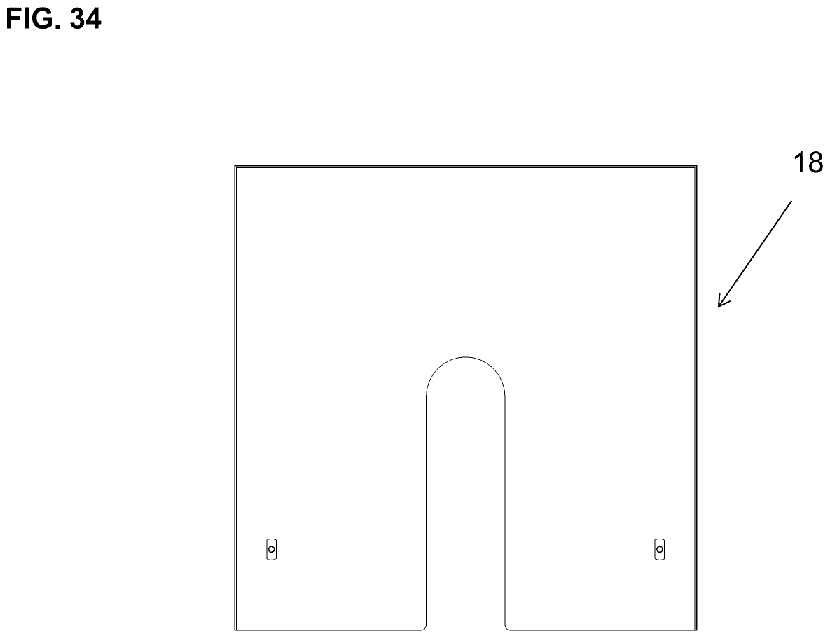

Turning now to FIGS. 21-27, an exemplary embodiment of a design for a mounting bracket 32 according to the present disclosure is shown. Additionally and with reference to FIGS. 28-34, an exemplary embodiment of a design for a shroud 18 according to the present disclosure is shown.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

### PARTS LIST

mounting system 10 output shaft 46
input shaft 48 electric motor 12
feet 50 gear reducer 14
I-beam mount 52 cooling fan 16
tie-rods 54 shroud 18
rear fastener openings 56 housing 20
front fastener openings 58 housing 22
first end 60 cooling fins 24
second end 62 secondary shaft 26
open bottom end 64 oil pump 28
fan cover region 66 oil cooler 30
bracket 32 air vents 68
feet 34 shaft slot 70
drive face 36 slot cover 72
lifting points 38 narrowed region 74
gussets 40 connectors 76
bottom rail 42 air inlet region 78
coupling 44 tapered zone 80
   radial extensions 82

What is claimed is:

1. A mounting system comprising:
an electric motor having an output shaft and a foot at a bottom of the electric motor;
a gear reducer having an input shaft at a drive face;
a coupling operatively connecting the output shaft to the input shaft; and
a mounting bracket secured to the drive face of the gear reducer and to the foot of the electric motor.

2. The mounting system of claim 1, further comprising a tie-rod secured to the mounting bracket on a side opposite the electric motor.

3. The mounting system of claim 1, wherein the mounting bracket comprises one or more lifting points.

4. The mounting system of claim 1, further comprising an I-beam mount secured to a reducer foot at a bottom of the gear reducer.

5. The mounting system of claim 4, further comprising a tie-rod secured to the I-beam mount on a side opposite the gear reducer.

6. The mounting system of claim 1, further comprising a fan operatively secured to the electric motor.

7. The mounting system of claim 6, wherein the fan draws in air axially across the gear reducer towards the electric motor and forces the air radially outward.

8. The mounting system of claim 7, wherein the gear reducer further comprises a secondary shaft driving an oil pump, the oil pump placing the gear reducer in fluid communication with an oil cooler, and wherein the oil cooler is positioned so that the air is forced across the oil cooler.

9. The mounting system of claim 6, further comprising a shroud between the electric motor and the gear reducer so as to cover the output shaft, the input shaft, the coupling, and the fan.

10. The mounting system of claim 1, further comprising a shroud between the electric motor and the gear reducer so as to cover the output shaft, the input shaft, and the coupling.

11. A mounting system comprising:
an electric motor having an output shaft;
a gear reducer having an input shaft at a drive face;
a coupling operatively connecting the output shaft to the input shaft;
a fan operatively secured to the electric motor; and
a shroud between the electric motor and the gear reducer so as to cover the output shaft, the input shaft, the coupling, and the fan, wherein the fan draws in air axially across the gear reducer and forces the air towards the electric motor where the air exits the shroud radially outward.

12. The mounting system of claim 11, wherein the gear reducer further comprises a secondary shaft driving an oil pump, the oil pump placing the gear reducer in fluid communication with an oil cooler, and wherein the oil cooler is positioned so that the air is forced across the oil cooler by the fan.

13. The mounting system of claim 11, further comprising a mounting bracket secured to the drive face of the gear reducer and to a foot at the bottom of the electric motor.

14. The mounting system of claim 13, wherein the mounting bracket comprises one or more lifting points.

15. The mounting system of claim 13, further comprising a tie-rod secured to the mounting bracket on a side opposite the electric motor.

16. The mounting system of claim 13, further comprising an I-beam mount secured to a reducer foot at a bottom of the gear reducer.

17. The mounting system of claim 16, further comprising an I-beam mount secured to a reducer foot at a bottom of the gear reducer.

18. The mounting system of claim 11, further comprising a tie-rod secured to the I-beam mount on a side opposite the gear reducer.
